(19) United States
(12) Patent Application Publication
(10) Pub. No.: US 2021/0114318 A1
(43) Pub. Date: Apr. 22, 2021

(54) METHOD FOR MANUFACTURING A PART MADE OF COMPOSITE MATERIAL COMPRISING A FIRST, THEN A SECOND POLYMERIZATION

(71) Applicant: Airbus Operations SAS, Toulouse (FR)

(72) Inventors: Bertrand DUTHILLE, TOULOUSE (FR); Jago PRIDIE, TOULOUSE (FR)

(21) Appl. No.: 17/074,754

(22) Filed: Oct. 20, 2020

(30) Foreign Application Priority Data
Oct. 22, 2019 (FR) 1911796

(51) Int. Cl. B29C 70/44; B29C 70/54

(52) U.S. Cl. CPC B29C 70/443; B29L 2031/3082; B29C 70/545

(57) ABSTRACT

A method for manufacturing a part made of composite material comprising a reinforcement made up of fibers impregnated with a resin matrix, comprising the steps of laying dry fibers flat and covering the dry fibers on a flat surface of a laying tool, infusing flat dry fibers with the resin; forming the dry fibers on a counter-mold, a first polymerization at a first polymerization temperature, the first polymerization being undertaken to obtain 20% to 30% hardening of the resin to obtain an intermediate reinforcement, the first polymerization being subsequent to the steps of infusing and of forming, demolding and machining the intermediate reinforcement, a second polymerization of the machined intermediate reinforcement at a second polymerization temperature, the value of the second temperature being greater than the value of the first temperature.

### CROSS-REFERENCES TO RELATED APPLICATIONS

This application claims the benefit of the French patent application No. 1911796 filed on Oct. 22, 2019, the entire disclosures of which are incorporated herein by way of reference.

### FIELD OF THE INVENTION

The present invention relates to a method for manufacturing a part made of composite material comprising a first, then a second polymerization.

### BACKGROUND OF THE INVENTION

A part made of composite material is made up of a reinforcement comprising fibers impregnated with a resin matrix. The fibers may or may not be woven.

According to a known embodiment, such a composite part can be produced according to a resin infusion method, called “Liquid Resin Infusion”. During such a method, dry fibers are placed in a vacuum via a vacuum film 4d on a counter-form 2, as shown in FIG. 1. The dry fibers are subsequently impregnated with the resin, which migrates by virtue of the vacuum. Such a method comprises a first step, called laying step, during which the dry fibers are laid or stacked on the counter-form 2. During a second step, called covering step, infusion consumables are introduced. “Infusion consumable” is understood to be all the elements required for infusing the reinforcement. During this covering step, the dry fibers are covered with peripheral fabrics. The peripheral fabrics are, by way of examples, a peel ply 4a disposed on the dry fibers, a semi-porous membrane 4b covering the peel ply 4a, a drain ply 4c covering the semi-porous membrane 4b. To enable homogeneous infusion of the fibers, the infusion is performed in a vacuum. The dry fibers and the peripheral fabrics are thus covered with a vacuum film 4d, also called “bladder”, that is configured to create a hermetic chamber S around the dry fibers. According to one embodiment, the vacuum film 4d is sealed with the counter-form 2 by at least one peripheral seal 3. To allow resin to be introduced into the chamber and to allow the air suction in order to create the vacuum, the vacuum film 4d comprises a first orifice 5a connected to an infusion means and a second orifice 5b connected to a suction means. During a third step, called hot pressing step, the dry fibers are placed in a vacuum at a pressing temperature. This step allows the formation of folds between the dry fibers to be prevented and allows the dry fibers to be pressed during the infusion of the resin, in order to increase the fiber volume content in the part. During a fourth step, called infusion step, a vacuum is created through air suction using the suction means 5b and resin is injected by the infusion means 5a. Under the effect of the vacuum, the dry fibers are infused in order to create the reinforcement 1. During a fifth step, called polymerization step, the reinforcement 1 undergoes a polymerization cycle in order to be consolidated and to obtain a part made of composite material. After the polymerization step, the part made of composite material is demolded and machined during a sixth step. The polymerization of a part made of composite material can generate a phenomenon, called edge effect, due to the creep of the resin through the dry fibers and results in a peripheral thickness of the part made of composite material that is less than the desired thickness. The purpose of machining is to remove the peripheral zone in order to obtain a part made of composite material with a constant thickness. The part made of composite material is consequently manufactured with dimensions that are greater than the desired final dimensions, ready for the machining step.

The method according to the prior art has several disadvantages. Indeed, machining the solid composite part requires the use of specific tools capable of cutting such a part, which makes this step time-consuming and expensive. When the form of the part made of composite material does not correspond to the desired final form, it cannot be modified, since the part is no longer pliable. It consequently needs to be discarded. Finally, the step of hot pressing is time-consuming, since it involves having to wait for the pressing temperature to be reached.

The invention relates to a method for manufacturing a part made of composite material aiming to simplify the manufacture of a part made of composite material.

### SUMMARY OF THE INVENTION

The present invention proposes a method for manufacturing a part made of composite material that does not have the disadvantages of the prior art.

To this end, it relates to a method for manufacturing a part made of composite material comprising a reinforcement made up of fibers impregnated with a resin matrix. The method is noteworthy in that it comprises the following steps:

flat laying and covering dry fibers on a flat surface of a laying tool;

infusing the dry fibers with the resin;

forming the dry fibers on a counter-mold;

first polymerization at a first polymerization temperature, the first polymerization being configured to obtain 20% to 30% hardening of the resin in order to obtain an intermediate reinforcement, the first polymerization being subsequent to the step of infusing and of forming;

demolding and machining the intermediate reinforcement;

second polymerization of the machined intermediate reinforcement at a second polymerization temperature, the value of the second temperature being greater than the value of the first temperature.

Such a manufacturing method allows the pressing step of the prior art to be dispensed with, and allows the manufacturing method to be simplified, with the laying and covering step and the infusion step being performed on the same tool. If necessary, after the first polymerization, the intermediate reinforcement can be reworked and machined, thus avoiding having to be scrapped for non-compliance.

According to one embodiment, the forming step is prior to the infusion of the dry fibers.

According to a second embodiment, the forming step is subsequent to the infusion of the dry fibers.

Such a manufacturing method comprises other noteworthy features, taken individually or in combination:

the step of infusing dry fibers is performed at an infusion temperature of 110° C.;

the forming step is performed at a temperature below 30° C.;

the first polymerization is performed at a temperature that is less than or equal to 150° C., for a duration that is less than or equal to 60 minutes, preferably that is equal to 150° C. for 60 minutes;

the second polymerization is performed at a temperature that is less than or equal to 180° C., for a duration that is less than or equal to 120 minutes, preferably that is equal to 180° C. for 120 minutes.

### BRIEF DESCRIPTION OF THE DRAWINGS

Further performance characteristics, details and advantages of the invention will become more clearly apparent from the detailed description, which is provided hereafter by way of an example, with reference to the drawings, in which:

FIG. 1 is a section view of a reinforcement and of infusion consumables during an infusion step of a resin infusion method according to the prior art;

FIG. 2 is a perspective view of an aircraft and of a central wing box;

FIG. 3 is an exploded view of a central wing box comprising at least one angle section of an aircraft made of composite material manufactured on the basis of the method for manufacturing a part made of composite material according to one embodiment of the invention;

FIG. 4 is a view showing the steps of a method for manufacturing a part made of composite material according to one embodiment of the invention; and

FIG. 5 is a section view of a tool for laying a reinforcement and of infusion consumables during an infusion step of the method for manufacturing a part made of composite material.

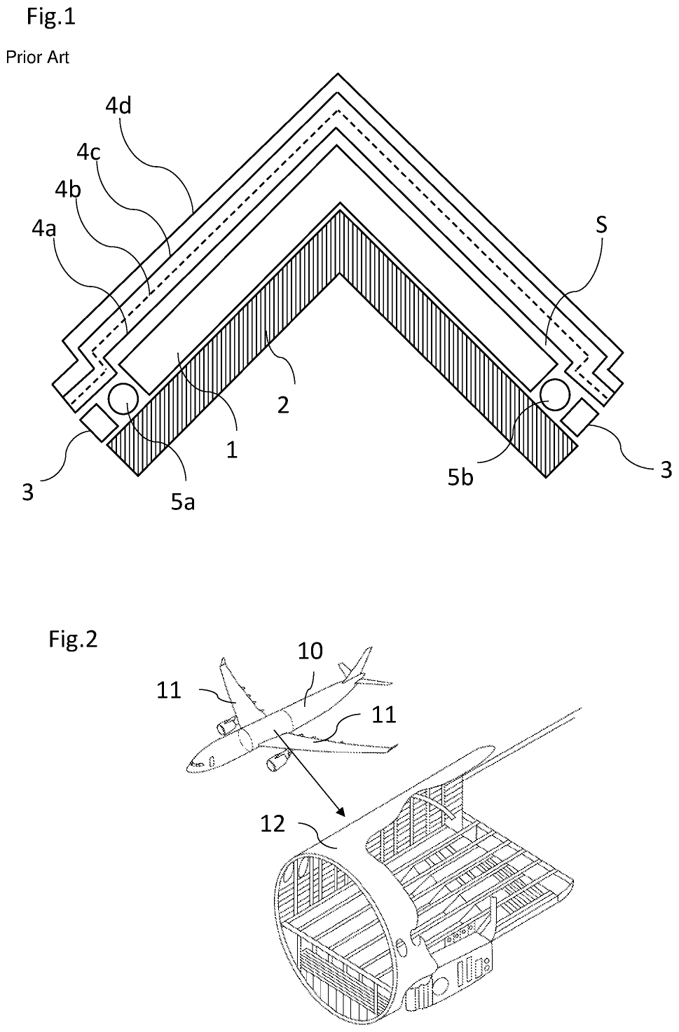

### DETAILED DESCRIPTION OF THE PREFERRED EMBODIMENTS

As illustrated in FIG. 2, the structure of an aircraft comprises a fuselage 10 and a wing 11 connected by a central wing box 12.

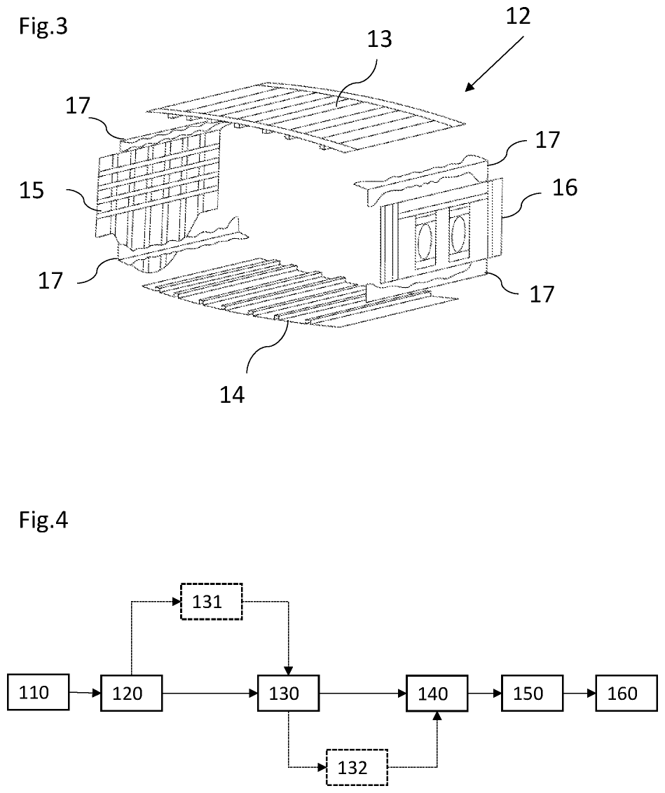

A central wing box 12 can be produced from parts made of composite material, such as an upper panel 13, a lower panel 14, a front spar 15 and a rear spar 16. The upper and lower panels 13, 14 and the front and rear spars 15, 16 are assembled pairwise using L-shaped angle sections 17, so as to form the central wing box 12, as shown in FIG. 3.

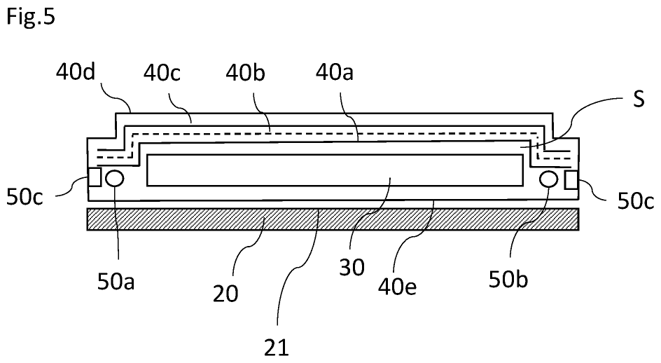

FIG. 4 shows a method for manufacturing a part made of composite material of a central wing box 12 of an aircraft, for example, an L-shaped angle section 17. The method comprises a first step of flat laying 110 dry fibers. The dry fibers are laid flat on a first vacuum film 40e placed on a flat surface 21 of a laying tool 20, as shown in FIG. 5.

This step is followed by a covering step 120 configured to introduce infusion consumables. By way of an example, this covering step 120 involves successively disposing peripheral fabrics on the folds of dry fibers, such as a peel ply 40a disposed above the dry fibers, a semi-porous membrane 40b covering the peel ply 40a, and a drain ply 40c covering the semi-porous membrane 40b. The dry fibers and the peripheral fabrics are retained in a hermetic chamber S by at least one vacuum film 40d. The dimensions of the peripheral fabrics 40a, 40b, 40c and of the at least one vacuum film 40d are greater than the dimensions of the dry fibers, so that the periphery of the peripheral fabrics 40a, 40b, 40c covers the entire free face of the dry fibers and partially covers the laying tool 20. The vacuum film 40d comprises a first orifice 50a configured to be connected to an infusion means and a second orifice 50b configured to be connected to a suction means. Subsequently, the first and second vacuum films 40e and 40d are joined at the periphery thereof, in order to create the hermetic chamber S around the dry fibers. The first and second vacuum films 40e and 40d can be heat-sealed or can be joined by a peripheral seal 50c, thus forming a hermetic bag around the dry fibers.

The method subsequently comprises a step 130 of infusing dry fibers. During such a step 130, the infusion means introduces resin into the hermetic chamber S via the first orifice 50a, and the suction means sucks the air present in the chamber via the second orifice 50b, forcing the resin through the dry fibers in order to create a reinforcement 30. In order to facilitate the movement of the resin inside the dry fibers, the infusion is performed at an infusion temperature that is configured to reduce the viscosity of the resin, for example, 110° C.

According to a first alternative embodiment, the method comprises a forming step 131 prior to the infusion step 130. During such a forming step 131, the dry fibers contained in the hermetic bag are positioned on a counter-form matching the form of the desired composite part. During the forming step 131, a vacuum can be created in the hermetic bag, promoting the forming of the dry fibers on the surface of the counter-form.

According to a second alternative embodiment, the method comprises a forming step 132 subsequent to the infusion step 130. The infusion step 130 is consequently performed flat, for example, on the laying tool 20, which promotes the movement of the resin through the dry fibers and accelerates the infusion compared to infusion that is not performed flat. Following the infusion step 130, the reinforcement 30 that is thus created is moved onto a counter-form, not shown in the figures. The resin present between the fibers acts as a lubricant and promotes the forming of the reinforcement 30. The forming step 132 is carried out at ambient temperature, preferably at 30° C.

Once the reinforcement 30 is positioned on the counter-form, the method comprises a first polymerization 140 of the reinforcement 30 at a first polymerization temperature T1. This step 140 is configured to harden the resin by 20% to 30%. The reinforcement that is thus obtained, called intermediate reinforcement, can be manipulated by an operator, i.e., it is not completely solidified and its geometry can be modified. By way of an example, the first polymerization 140 is performed at a temperature that is less than or equal to 150° C. for a duration that is less than or equal to 60 minutes. Preferably, the first polymerization 140 is performed at a temperature T1 that is equal to 150° C., for 60 minutes.

The method subsequently comprises a step 150 of demolding and of machining the intermediate reinforcement. With the intermediate reinforcement being partially polymerized and semi-hard, it maintains the desired final form, whilst being pliable in order to remove the infusion consumables, perform any rework and proceed to machining By way of examples, holes or orifices can be machined, the peripheral edges can be cut in order to adapt the dimensions of the intermediate reinforcement 30 to the dimensions of the desired composite part and at the same time remove the edge effects that appear during polymerization, etc. Machining on the intermediate reinforcement allows clean machined edges to be obtained.

Once the intermediate reinforcement is machined, it is positioned on the counter-form before undergoing a second polymerization 160 that is configured to solidify the intermediate reinforcement and to obtain the final part made of composite material. The value of the second polymerization temperature T2 is consequently higher than the value of the first polymerization temperature. By way of an example, the second polymerization 160 is performed at a second polymerization temperature T2 that is less than or equal to 180° C. for a duration that is less than or equal to 120 minutes, preferably 180° C. for 120 minutes. According to one embodiment, during the second polymerization 160 the intermediate reinforcement is polymerized between a female part and a male part of a mold, consequently promoting homogeneous distribution of the heat and homogeneous polymerization of the intermediate reinforcement.

The polymerization temperatures T1 and T2 can be achieved by infrared radiation, by means of infrared lamps positioned in the vicinity of the reinforcement 30 or by convection via the forming tool 20.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing a part made of composite material comprising a reinforcement made up of fibers impregnated with a matrix formed of a resin, wherein the method comprises the following successive steps:
laying dry fibers flat and covering the dry fibers on a flat surface of a laying tool;
infusing the flat dry fibers with the resin;
forming the dry fibers on a counter-mold;
first polymerizing of the resin at a first polymerization temperature, the first polymerizing being undertaken to obtain 20% to 30% hardening of the resin to obtain an intermediate reinforcement, the first polymerizing being subsequent to the steps of infusing and of forming;
demolding and machining the intermediate reinforcement;
second polymerizing of the machined intermediate reinforcement at a second polymerization temperature, the second polymerization temperature being greater than the first polymerization temperature.

2. The method for manufacturing the part made of composite material according to claim 1, wherein the step of infusing dry fibers is performed at an infusion temperature of 110° C.

3. The method for manufacturing the part made of composite material according to claim 1, wherein the forming step is performed at a temperature below 30° C.

4. The method for manufacturing the part made of composite material according to claim 1, wherein the first polymerization temperature is less than or equal to 150° C., and the resin is held at this temperature for a duration of less than or equal to 60 minutes.

5. The method for manufacturing the part made of composite material according to claim 4, wherein the first polymerization temperature is 150° C. and the resin is held at this temperature for 60 minutes.

6. The method for manufacturing the part made of composite material according to claim 1, wherein the second polymerization temperature is less than or equal to 180° C., and the resin is held at this temperature for a duration that is less than or equal to 120 minutes.

7. The method for manufacturing the part made of composite material according to claim 6, wherein the second polymerization temperature is 180° C. and the resin is held at this temperature for 120 minutes.
